(19) United States
(12) Patent Application Publication
(10) Pub. No.: US 2009/0226131 A1
(43) Pub. Date: Sep. 10, 2009

(54) Fiber Optic Rotary Coupler

(75) Inventors: Boying B. Zhang, Lawrenceville, NJ (US); Hong Zhang, Plainsboro, NJ (US)

Correspondence Address: Lu & Associates, P.C., P.O. Box 1380, HAVERTOWN, PA, 19083, US

(73) Assignee: PRINCETEL, INC., Pennington, NJ (US)

(21) Appl. No.: 12/042,126

(22) Filed: Mar. 4, 2008

(51) Int. Cl. G02B 6/26

(52) U.S. Cl. 385/26

(57) ABSTRACT

A fiber optic rotary coupler is invented using both single mode and multi-mode optic fibers. This device has a rotatable optic fiber and a stationary optic fiber in an assembly to convey a light beam in the optic fibers. The assembly also includes a stationary fiber holder for fixing the tip of stationary optic fiber in a central hole and a rotatable fiber holder for fixing the body of the rotatable optic fiber with the tip of the rotatable fiber protruding out of the rotatable fiber holder. The two fiber holders can be rotated relatively each other so as to allow the tip of rotatable optic fiber to rotate in the central hole on the stationary fiber holder with the tips of the two optic fibers adjacent very closely.

### REFERENCES CITED

### U.S. PATENT DOCUMENTS

| | | |
|---|---|---|
| 5,039,193 | August 1991 | Snow et al. |
| 4,124,272 | November 1978 | Henderson et al. |
| 5,633,963 | May 1997 | Rickenbach et al. |
| 5,949,929 | September 1999 | Hamm |

### OTHER PUBLICATIONS

“Fiber Optic Rotary Couplers-A Review”, by GLENN F. I. DORSEY. IEEE Trans. Components, Hybrids, and Manufac. Technol., vol. CHMT-5, NO. 1, 1982, PP 39.

“Design and Implementation of a Broad Band OpticRotary Coupler Using C-lenses”, by Wencai Jing et al., Optics Express, vol. 12, NO.17, 23 August 2004. PP 4088-4093.

### BACKGROUND OF THE INVENTION

1. Field of the Invention

The invention is related to single channel fiber optic rotary coupler in the field of optic communication to ensure that the device has low insertion loss, small insertion loss variation, and high return loss.

2. Description of Related Art

The Fiber optic Rotary Coupler is the optic equivalent of the electrical slip ring. It allows uninterrupted transmission of an optic signal in a fiber guide through a rotational interface to a stationary apparatus. The Fiber optic Rotary Coupler is widely used in missile guidance systems, robotic systems, remotely operated vehicles, oil drilling systems, sensing systems, and many other field applications where a twist-free fiber cable is essential. Combined with electrical slip rings or fluid rotary couplers, Fiber optic Rotary Coupler adds a new dimension to traditional slip rings. As fiber optic technology advances, more and more traditional slip ring users will benefit from Fiber optic Rotary Coupler in their new fiber systems.

Comparing with its electrical counterpart, the electrical slip ring, the Fiber optic Rotary Coupler is not easy to fabricate because the transmission of the light beam through a fiber is strongly depend on its geometrical structure and related position. So it requires special design to ensure the transmission of light beam through a relative rotating coupler without suffering a large loss. A couple of prior inventions of single channel fiber optic rotary coupler are described in the following patents: U.S. Pat. No. 5,039,193, U.S. Pat. NO. 4,124,272, U.S. Pat. No. 5,633,963, and U.S. Pat. No. 5,949,929. Most of them employ the expanded beam technology, i.e., using lenses to expand the light beam and collimate it before transmitting to a rotary coupler. The beam is then refocused and aligned with the receiving fiber. The lenses include graded index rod lens, aspheric lens, and GRIN lens. This method has several significant drawbacks. First, this kind of rotary coupler require special fixture to have lenses aligned. Secondly, using high quality lenses would increase the sizes and cost of fiber optic rotary couplers. Further, to maintain the axial alignment is difficult so that this kind of rotary coupler is vulnerable in such environments as temperature change, vibration and shock.

### SUMMARY OF THE INVENTION

The first object of the present invention is to minimize the need for maintaining precise axial alignment between the rotating and non-rotating elements of a single channel fiber optic rotary coupler so that it could be used in any harsh environments such as temperature change, vibration and shock.

Another object of the present invention is to provide a single channel fiber optic rotary coupler with a very low-profile and compact design.

A further objective of the preset invention is to reduce the insertion loss and increase return loss and to allow the rotary coupler to work at any ambient pressure by filling index-matching fluid.

### BRIEF DESCRIPTION OF THE DRAWINGS

FIG. 1 is a cross section view of one embodiment of the invention. There are a rotatable optic fiber and a stationary optic fiber to convey a light beam in a rotary interface.

### DETAILED DESCRIPTION OF THE INVENTION

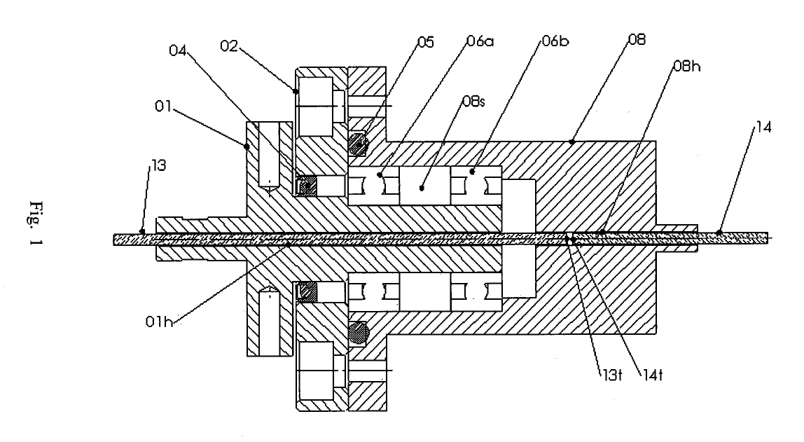

As shown in FIG. 1, a typical design of the present invention comprises a rotatable fiber holder 01 and a stationary fiber holder 08. A pair of bearing 06a and 06b are mounted in the bore of stationary fiber holder 08 and on the shaft of rotatable fiber holder 01 so that the rotatable fiber holder 01 is able to rotate around the axis of the bore of stationary fiber holder 08.

Both rotatable fiber holder 01 and a stationary fiber holder 08 are designed with a through central holes 01h and 08h respectively. A rotatable optic fiber 13, having a tip 13t, is fixed in the central hole 01h of the rotatable fiber holder 01 with the tip 13t protruded out of the rotatable fiber holder 01. A stationary optic fiber 14, having a tip 14t, is fixed in the central hole 08h of stationary fiber holder 08 with the tip 14t recessed in the central hole 08h of the stationary fiber holder 08. The tip 13t and 14t are adjacent very closely. Because the diameter of hole 08h is slightly larger than the diameter of fiber 13, the tip 13t of fiber 13 and the central hole 08h of the stationary fiber holder 08 mechanically forms a so-called “micro bearing, or “micro rotational interface. When the rotatable fiber holder 01 rotates relative to the stationary fiber holder 08, the rotatable optic fiber 13 is able to rotate relatively to the stationary optic fiber 14 co-axially so as to transmit the optic signal from one fiber to another fiber bi-directionally.

The length of protrusion portion of the optic fiber 13 is deliberately designed to have enough flexibility to compensate the mechanical alignment error of the two fibers provided by bearings 06a and 06b. The mechanical alignment error of a fiber optical rotary coupler could be 10 to 20 um by a conventional fabrication and assembly procedure. For the present invention, the maximum alignment error of the fiber 13a and fiber 13b is only about 0.5 um so that the insertion loss is greatly improved. And by using of the “micro bearing, the whole size of the fiber optical rotary coupler could be greatly reduced.

The optic fibers, 13 and 14, could be single mode, or multi-mode with a flat end surface, or an 8-degree facet to improve the return loss, or with a thermally expanded end surface.

The optic fibers, 13 and 14, could also be Thermally Expanded Core (TEC) fiber, or micro-collimators with the similar diameter as the conventional optic fibers.

An index matching fluid is filled in the inner open space 08s of the stationary fiber holder 08. The shaft seal 04 and o-ring 05 are utilized to seal the space 08s. One function of the index matching fluid is for the lubrication between bearings and the “micro bearing Another function of index matching fluid is for pressure compensating purposes. The whole space 08s inside the stationary fiber holder 08 could be used as the pressure compensation chamber. The shaft seal 04 is located between the shaft of rotatable fiber holder 01 and the bore of seal cover 02. The space from seal 04 to bearing 06a is designed large enough to allow the shaft seal 04 to slid axially like a piston to balance ambient pressure with the pressure inside the stationary fiber holder 08.

1. A fiber optic rotary coupler comprising:
a first fiber holder having a through hole for fiber mounting on one side and an inner open space co-axially on another side;
a second fiber holder having a through hole for fiber mounting and the said second fiber holder rotatably mounted in the said inner open space of said first fiber holder with the axis of said through hole of said first fiber holder aligned to the axis of said through hole of said second fiber holder;
a first optic fiber with a tip, a tail and longitudinal axis; said first optic fiber being firmly mounted in the said through hole of said first fiber holder with the tip of said first optic fiber recessing in the said through hole of said first fiber holder so that the said through hole of said first fiber holder is partially blocked by the said first fiber;
a second optic fiber having a tip, a tail and longitudinal axis; said second optic fiber being firmly mounted in the said through hole of said second fiber holder with the tip of said second optic fiber protruding out of said second fiber holder and get into the said through hole of said first fiber holder;
a shaft seal mounted on said second fiber holder for sealing the said inner open space of said first fiber holder.

2. The fiber optic rotary coupler of claim 1 said the diameter of the said through hole in said first fiber holder being slightly larger than the diameter of said second fiber; the distance between the tips of said first optic fiber and said second optic fiber being less than 10 times of the diameter of the said second optic fiber.

3. The fiber optic rotary coupler of claim 1 including a sealed space in the said inner open space of said first fiber holder, filled with index matching fluid.

4. The fiber optic rotary coupler of claim 3 and claim 1 wherein said a shaft seal able to slid on the said second fiber holder axially for compensate the ambient pressure and the pressure inside the said sealed space able to be adjusted by the axial movement of said shaft seal.
